(19) United States
(12) Patent Application Publication
(10) Pub. No.: US 2025/0309573 A1
(43) Pub. Date: Oct. 2, 2025

(54) CONNECTION WIRE

(71) Applicant: Lexar Electronics (Shenzhen) Co., Ltd., SHENZHEN (CN)

(72) Inventors: Zutao QIU, SHENZHEN (CN); Jinbiao CHEN, SHENZHEN (CN); Wei LIN, SHENZHEN (CN); Xiping ZHOU, SHENZHEN (CN)

(21) Appl. No.: 19/074,331

(22) Filed: Mar. 8, 2025

(30) Foreign Application Priority Data
Mar. 28, 2024 (CN) 202410377196.X

(51) Int. Cl. H01R 12/75; H01R 12/70; H01R 13/502; H01R 13/62; H01R 13/621; H01R 13/629

(52) U.S. Cl. CPC H01R 12/75; H01R 12/7076; H01R 13/502; H01R 13/6205; H01R 13/621; H01R 13/629

(57) ABSTRACT

A connection wire includes: a connection component, including a first connector, a circuit board, a second connector, and a data line. A first end of the data line is connected to the first connector, a second end of the data line is connected to the circuit board, and the circuit board is further connected to the second connector; the second end is opposite to the first end; a fixation component, fixedly arranged at the second end of the data line to fix the second end of the data line to a fixed object.

### CROSS REFERENCE TO RELATED APPLICATIONS

The present application claims the priority of the Chinese patent application No. 202410377196.X, filed on Mar. 28, 2024, the entire contents of which are hereby incorporated by reference in their entireties.

### TECHNICAL FIELD

The present disclosure relates to the technical field of connection structures, and in particular to a connection wire.

### BACKGROUND

For a user who uses various intelligent devices, a connection wire may be applied in various scenarios.

Various electronic devices may be connected to each other through the connection wire, and various functions can be achieved. However, after the various electronic devices are connected to each other through the connection wire, the connection wire may be suspended and cannot be fixed to anywhere.

### SUMMARY OF THE DISCLOSURE

The present disclosure provides a connection wire to solve the technical problem that the connection wire is suspended and cannot be fixed to anywhere.

In a first aspect, the present disclosure provides a connection wire, including: a connection component, including a first connector, a circuit board, a second connector, and a data line. A first end of the data line is connected to the first connector, a second end of the data line is connected to the circuit board, and the circuit board is further connected to the second connector; the second end is opposite to the first end; a fixation component, fixedly arranged at the second end of the data line to fix the second end of the data line to a fixed object.

In some embodiments, the fixation component includes a body portion. The body portion defines a first through hole and a second through hole; a side of the body portion away from the first connector defines a receiving cavity that is communicated with the first through hole and the second through hole; and the circuit board is received in the receiving cavity. The second end of the data line is fixedly inserted in the first through hole and connected to a side of the circuit board in the receiving cavity. The second connector is fixedly inserted in the second through hole and connected to the same side of the circuit board in the receiving cavity.

In some embodiments, a fixation protrusion is formed on a first side of the body portion; the second through hole is defined in the fixation protrusion.

In some embodiments, each of two opposite sides of a side edge of the fixation protrusion near the body portion is arranged with a third fixation member to be secured to a connection object of the second connector; the third fixation member includes a mortise groove, a tenon, a magnetic adsorption point or a fixation hole.

In some embodiments, the fixation component further includes a fixation portion. The fixing portion includes a first fixation member and a second fixation member, which are laminated and parallel to each other; the first fixation member and the second fixation member are perpendicular to and fixedly connected to a second side of the body portion; the second side is opposite to the first side of the body portion.

In some embodiments, the second fixation member includes a movable member. The movable member is movably connected to the first fixation member to adjust a distance between the movable member and the first fixation member to fix the first fixation member to the fixed object.

In some embodiments, the second fixation member further includes a fixation body, and the movable member includes a screw and a rotation snap. An end of the screw sequentially extends through and is threadedly connected to the fixation body, the rotation snap, and the first fixation member; a distance between the rotation snap and the first fixation member is adjusted by the rotation snap to fix the first fixation member with the fixed object; and the other end of the screw is configured to be connected to an external structure.

In some embodiments, the screw has a size of ¼ inches.

In some embodiments, the fixation component further includes two fourth fixation members and a fixation plate. The fixation plate is perpendicular to and fixedly connected to a second side of the body portion. An end of one of the two fourth fixation members is connected to one of two opposite ends of a side of the fixation plate away from the first connector; and an end of the other one of the two fourth fixation members is connected to the other one of the two opposite ends of the side of the fixation plate away from the first connector. The other end of one of the two fourth fixation members and the other end of the other one of the two fourth fixation members are bent towards each other and parallel to the side of the fixation plate away from the first connector; two fixation grooves are formed on the side of the fixation plate away from the first connector.

In some embodiments, each of the first connector and the second connector is: an HDMI connector, a Type-C female connector, a USB-A connector, a Type-C male connector or a DP connector.

According to the present disclosure, the connection wire includes a connection component and a fixation component. The connection component includes a first connector, a circuit board, a second connector, and a data line. A first end of the data line is connected to the first connector. A second end of the data line is connected to the circuit board. The circuit board is further connected to the second connector. The second end is opposite to the first end. The fixation component is fixedly disposed at the second end of the data line to fix the second end of the data line to a fixed object. In this way, the fixation component may fix the suspended data line to the fixed object, connection stability of the connection wire is improved, and instability caused by the data line being suspended may be prevented.

### BRIEF DESCRIPTION OF THE DRAWINGS

FIG. 1 is an exploded view of a connection wire according to a first embodiment of the present disclosure.

FIG. 2 is a side plane view of the connection wire according to the first embodiment of the present disclosure.

FIG. 3 is a structural schematic view of the connection wire, being viewed from a viewing angle, according to the first embodiment of the present disclosure.

FIG. 4 is a side plane view of the connection wire according to a second embodiment of the present disclosure.

FIG. 5 is a front plane view of the connection wire according to the second embodiment of the present disclosure.

### DETAILED DESCRIPTION

The technical solutions in the embodiments of the present disclosure will be described clearly and completely in the following by referring to the accompanying drawings in the embodiments of the present disclosure. Apparently, the described embodiments are only a part of, not all of, the embodiments of the present disclosure. All other embodiments, which are obtained by any ordinary skilled person in the art based on the embodiments in the present disclosure without making creative work, shall be within the scope of the present disclosure.

It should be noted that directional indications (such as up, down, left, right, front, rear . . . ) are only used to explain a relative positional relationship and movement between components in a particular attitude (the attitude as shown in the drawings), and when the particular attitude changes, the directional indications may be changed accordingly.

In addition, terms “first”, “second”, and so on are used only for the purpose of description and shall not be interpreted as indicating or implying relative importance or implicitly specifying the number of indicated technical features. Therefore, a feature defined by the “first” or “second” may explicitly or implicitly include at least one such feature. In addition, technical solutions of various embodiments can be combined with each other, but the combination must be achievable by any ordinary skilled person in the art. When combination of some technical solutions is contradictory or unachievable, the combination of the technical solutions does not exist and is not included in the scope of the present disclosure.

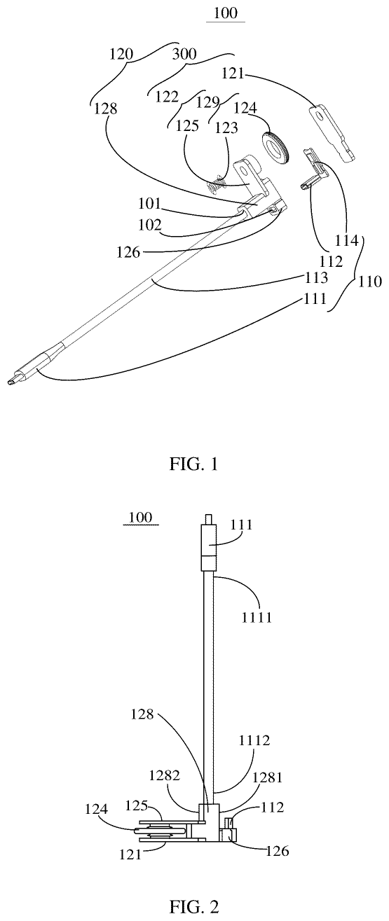

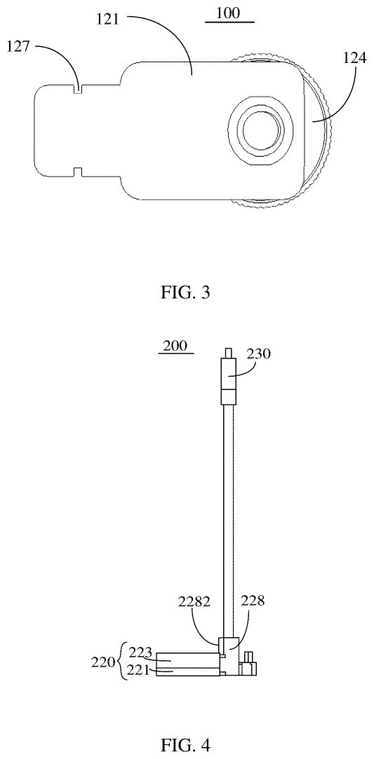

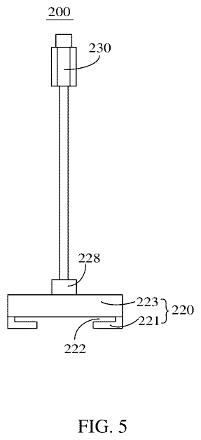

As shown in FIGS. 1-3, FIG. 1 is an exploded view of a connection wire according to a first embodiment of the present disclosure; FIG. 2 is a side plane view of the connection wire according to the first embodiment of the present disclosure; and FIG. 3 is a structural schematic view of the connection wire, being viewed from a viewing angle, according to the first embodiment of the present disclosure.

The connection wire 100 of the present embodiment includes: a connection component 110 and a fixation component 120. The connection component 110 is a connection structure for achieving a connection function of the connection wire 100. The fixation component 120 is a component for fixing the connection wire 100 to a fixed object. The fixed object is an external device of the connection wire 100, a specific structure of the fixed object may be determined accordingly based on application scenarios.

The connection component 110 includes a first connector 111, a circuit board 114, a second connector 112, and a data line 113. A first end 1111 of the data line 113 is connected to the first connector 111, a second end 1112 of the data line 113 is connected to the circuit board 114. The circuit board 114 is further connected to the second connector 112; the second end 1112 is opposite to the first end 1111. That is, the first connector 111, the data line 113, the circuit board 114, and the second connector 112 are sequentially connected to each other to achieve the connection function of the connection wire 100. The data line 113 is a flexible data line, such that the connection wire 100 may be adaptively deformed to be applicable to various application scenarios to be adaptive to various connection objects. The first connector 111 is configured to connect with a first connection object located outside of the connection wire. The second connector 112 is configured to connect with a second connection object located outside of the connection wire. The first connection object and the second connection object may be determined based on specific connection demands of the connection wire 100.

The fixation component 120 is fixedly disposed at the second end 1112 of the data line 113 to fix the second end 1112 of the data line 113 to the fixed object. That is, when the first connector 111 and the second connector 112 of the connection wire 100 are respectively connected with the first connection object and the second connection object, the fixation component 120 may be used to fix the suspended data line 113 to the fixed object outside of the connection wire. In this way, connection stability of the connection wire 100 is improved, and instability, caused by the data line 113 being suspended, may be reduced.

In an application scenario, when a camera needs to be connected to an external functional device via the connection wire 100, the first connector 111 of the connection wire 100 may be connected to the external functional device, and the second connector 112 may be connected to a corresponding interface of the camera, the fixation component 120 of the second end 1112 of the data line 113 may be fixed to a hot shoe/dovetail groove of the camera, such that the suspended data line 113 is fixed, and connection stability of the connection wire 100 is improved.

In an application scenario, when a smart mobile terminal is loaded on a phone cage (a kind of anti-shaking device), the smart mobile terminal needs to be connected to an external functional device. The first connector 111 of the connection wire 100 may be connected to the smart mobile terminal, the second connector 112 may be connected to the external functional device. Further, the fixation component 120 of the second end of the data line 113 is fixed to the dovetail groove of a bracket of the phone cage. In this way, the suspended data line 113 is fixed, and connection stability of the connection wire 100 is improved. The functional device includes, but limited to: a storage device, a microphone, a flash, a power adapter, a fill light, and so on. Specific application scenarios of the connection wire 100 are not limited herein. The fixed object may be adaptively adjusted based on the application scenario, which will not be limited herein.

According to the above disclosure, in the present embodiment, the connection wire includes the connection component and the fixation component. The connection component includes the first connector, the circuit board, the second connector, and the data line. The first end of the data line is connected to the first connector, the second end of the data line is connected to the circuit board, and the circuit board is further connected to the second connector. The second end is opposite to the first end. The fixation component is fixedly disposed at the second end of the data line to fix the second end of the data line to the fixed object. In this way, the fixation component may fix the suspended data line to the fixed object, connection stability of the connection wire is improved, and instability, caused by the data line being suspended. may be prevented.

In some embodiments, the fixation component 120 includes a body portion 128. The body portion 128 defines a first through hole 101 and a second through hole 102. A side of the body portion 128 away from the first connector 111 defines a receiving cavity (not shown in the drawings), communicated with the first through hole 101 and the second through hole 102. The circuit board 114 is received in the receiving cavity.

The second end 1112 of the data line 113 is fixedly inserted in the first through hole 101 and is connected to a side of the circuit board 114 in the receiving cavity. The second connector 112 is fixedly inserted in the second through hole 102 and connected to the same side of the circuit board 114 in the receiving cavity. That is, the first connector 111 and the second connector 112 are disposed on the same side of the circuit board 114, such that a larger space is reserved at the second end 1112 of the data line 113. A larger space is defined in the fixation component 120, facilitating the fixation component 120 and the fixed object to be sufficiently fixed to each other.

In some embodiments, a fixation protrusion 126 is formed on a first side 1281 of the body portion 128; the second through hole 102 is defined in the fixation protrusion 126. The fixation protrusion 126 may be integrally formed with the body portion 128.

In some embodiments, each of two opposite sides of an edge of a side of the fixation protrusion 126 near the body portion 128 defines a third fixation member 127, and the third fixation member 127 is secured to the connection object of the second connector 112. The number of third fixation members 127 may be one or more, and the number may be determined based on actual needs.

In an application scenario, the third fixation member 127 includes a mortise groove, and a tenon is correspondingly arranged on the second connection object of the second connector 112. When the second connection object is connected to the second connector 112, the mortise groove defined in the third fixation member 127 and the tenon arranged on the second connection object are correspondingly snapped with each other for fixing. In this way, stability and reliability of the entire topology after the second connector 112 being connected to the second connection object are improved, and loosening of the second connection object may be prevented.

In some embodiments, the third fixation member includes the tenon, and the mortise groove is correspondingly defined in the second connection object of the second connector. When the second connection object is connected to the second connector, the third fixation member and the mortise groove in the second connection object are correspondingly snapped to each other for fixing. In this way, stability and reliability of the entire topology after the second connector being connected to the second connection object are improved, and loosening of the second connection object may be prevented.

In some embodiments, the third fixation member includes a fixation hole. The fixation hole may be located on a side of the fixation protrusion near the first connector. At least one fixation pin is correspondingly arranged on the second connection object. The fixation hole may include a blind hole or a through hole. A depth of the fixation hole can receive a respective one of the at least one fixation pin. When the second connection object is connected to the second connector, each of the at least one fixation pin on the second connection object is correspondingly inserted in the fixation hole for fixing. In this way, stability and reliability of the entire topology after the second connector being connected to the second connection object are improved, and loosening of the second connection object may be prevented.

In some embodiments, the third fixation member includes a magnetic absorption N pole, the magnetic absorption N poleis arranged on the side of the fixation protrusion near the first connector. A magnetic absorption S pole is correspondingly arranged on the second connection object. When the second connection object is connected with the second connector, the magnetic absorption S pole on the second connection object is correspondingly magnetically adsorbed to the magnetic absorption N pole on the side of the fixation protrusion near the first connector for fixing. Alternatively, the third fixation member includes the magnetic absorption S pole, the magnetic absorption S pole is arranged on the side of the fixation protrusion near the first connector; the magnetic absorption N poleis correspondingly arranged on the second connection object. When the second connection object is connected to the second connector, the magnetic absorption N pole on the second connection object is correspondingly magnetically adsorbed to the magnetic absorption S pole on the side of the fixation protrusion near the first connector for fixing. In this way, stability and reliability of the entire topology after the second connector being connected to the second connection object are improved, and loosening of the second connection object may be prevented. The third fixation member may be configured as, but not limited to: mortise and tenon for fixing, threads for fixing, magnetic adsorption for fixing, or adhesive for fixing.

In some embodiments, the fixation component 120 further includes a fixation portion 300. The fixation portion 300 includes a first fixation member 121 and a second fixation member 122 that are laminated and are disposed in parallel to each other. The first fixation member 121 and the second fixation member 122 are perpendicular to and fixedly connected to a second side 1282 of the body portion 128. The second side 1282 is opposite to the first side 1281 of the body portion 128.

In an application scenario, when the dovetail groove is defined in the fixed object of the fixation component 120, the fixation component 120 may be fixed by inserting the first fixation member 121 into the dovetail groove of the corresponding fixed object.

The fixation portion 300 and the fixation protrusion 126 are respectively disposed on two opposite sides of the body portion 128, such that the fixing function of the fixation component 120 does not interfere with the connection function of the connection component 110, and freedom of the fixation component 120 and freedom of the connection component 110 are both improved.

In some embodiments, the second fixation member 122 includes a movable member 129. The movable member 129 is movably connected to the first fixation member 121 to adjust a distance between the first fixation member 121 and the movable member 129 and to fix the first fixation member 121 and the fixed object.

In an application scenario, the second fixation member 122 further includes a fixation body 125, and the movable member 129 includes a screw 123 and a rotation snap 124. An end of the screw 123 sequentially extends through and connects the fixing body 125, the rotation snap 124, and the first fixation member 121, so as to connect the fixation body 125, the rotation snap 124, and the first fixation member 121 with each other. The other end of the screw 123 is configured to be connected to external components. The other end of the screw may be connected to the microphone, the power adapter, the fill light, and so on.

Each of the fixation body 125, the rotation snap 124, and the first fixation member 121 correspondingly defines a threaded hole (not labeled in the drawings), so as to sleeve the screw 123. In order to expand an application range of the screw, the screw and the screw hole may be configured to have a size of ¼ inches.

A distance between the rotation snap 124 and the first fixation member 121 is adjusted based on the rotation snap 124, so as to fix the first fixation member 121 with the fixed object. In an application scenario, when the fixed object is the dovetail groove, each of the two opposite sides of the first fixation member 121 is inserted into the dovetail groove respectively. By adjusting the distance between the rotation snap 124 and the first fixation member 121, the rotation snap 124 and the first fixation member 121 may tightly clamp a top shell of two sides of the dovetail groove, such that fixation is achieved. Since, for the first fixation member 121, only the two opposite sides thereof need to be inserted into the dovetail groove, a middle region of the first fixation member 121 may define the threaded hole for fixing the screw 123.

In other embodiments, the moveable member 129 may further include a snap or a slide-rail bolt, so as to adjust the distance between the first fixation member 121 and the moveable member 129. A specific structure of the movable member 129 is not limited herein.

In some embodiments, the first connector 111 and the second connector 112 may be: a High Definition Multimedia Interface (HDMI) connecter, a Type-C female connector, a USB-A connector, a Type-C male connector, or a DisplayPort (DP) connecter. Specific types of the first connector 111 and the second connector 112 may be determined based on actual needs.

Structure of the connection component, the body portion, and the fixation protrusion of the connection wire 200 of the present embodiment is the same as that of the previous embodiment, which will not be repeated herein.

The fixation component 220 of the present embodiment further includes two fourth fixation members 221 and a fixation plate 223. The fixation plate 223 is perpendicular to and fixedly connected to the second side 2282 of the body portion 228. An end of one of the two fourth fixation members 221 is connected to one of two opposite ends of a side of the fixation plate 223 away from the first connector 230; and an end of the other one of the two fourth fixation members 221 is connected to the other one of the two opposite ends of the side of the fixation plate 223 away from the first connector 230. Furthermore, the two fourth fixation members 221 are bent, enabling the other end of one of the two fourth fixation members 221 and the other end of the other one of the two fourth fixation members 221 to be extending towards each other and to be parallel to the side of the fixation plate 223 away from the first connector 230. In this way, two fixation grooves 222 are formed on the side of the fixation plate 223 away from the first connector 230 to snap a protrusion of the fixed object, such that fixation is achieved.

According to the above structure, for the connection wire of the present embodiment, the fixation component is configured to fix the suspended data line on the fixed object, such that connection stability of the connection wire is improved, and instability, caused by the data line being suspended, may be prevented.

The above shows only embodiments of the present disclosure, and does to limit the scope of the present disclosure. Any equivalent structure or equivalent principle transformation, which are performed based on the contents of the specification and the accompanying drawings of the present disclosure and are applied directly or indirectly in other related fields, shall be equivalently included in the scope of the present disclosure.

What is claimed is:

1. A connection wire, comprising:
a connection component, comprising a first connector, a circuit board, a second connector, and a data line, wherein a first end of the data line is connected to the first connector, a second end of the data line is connected to the circuit board, and the circuit board is further connected to the second connector; the second end is opposite to the first end;
a fixation component, fixedly arranged at the second end of the data line to fix the second end of the data line to a fixed object.

2. The connection wire according to claim 1, wherein the fixation component includes a body portion;
the body portion defines a first through hole and a second through hole; a side of the body portion away from the first connector defines a receiving cavity that is communicated with the first through hole and the second through hole; and the circuit board is received in the receiving cavity;
the second end of the data line is fixedly inserted in the first through hole and connected to a side of the circuit board in the receiving cavity;
the second connector is fixedly inserted in the second through hole and connected to the same side of the circuit board in the receiving cavity.

3. The connection wire according to claim 2, wherein a fixation protrusion is formed on a first side of the body portion; the second through hole is defined in the fixation protrusion.

4. The connection wire according to claim 3, wherein,
each of two opposite sides of a side edge of the fixation protrusion near the body portion is arranged with a third fixation member to be secured to a connection object of the second connector.

5. The connection wire according to claim 4, wherein the third fixation member is a mortise groove, and the mortise groove is configured to be correspondingly snapped with a tenon arranged on the connection object of the second connector.

6. The connection wire according to claim 4, wherein the third fixation member is a tenon, and the tenon is configured to be correspondingly snapped with a mortise groove defined in the connection object of the second connector.

7. The connection wire according to claim 4, wherein the third fixation member is a magnetic adsorption member, and the adsorption member is configured to be correspondingly magnetically adsorbed to another magnetic adsorption member arranged on the connection object of the second connector.

8. The connection wire according to claim 4, wherein the third fixation member is a fixation hole, and the fixation hole is configured to be correspondingly snapped a fixation pin arranged on the connection object of the second connector.

9. The connection wire according to claim 8, wherein the fixation hole is defined in a side of the fixation protrusion near the first connector.

10. The connection wire according to claim 8, wherein the fixation hole is a blind hole or a through hole.

11. The connection wire according to claim 2, wherein
the fixation component further comprises a fixation portion;
the fixing portion comprises a first fixation member and a second fixation member, which are laminated and parallel to each other; the first fixation member and the second fixation member are perpendicular to and fixedly connected to a second side of the body portion; the second side is opposite to the first side of the body portion.

12. The connection wire according to claim 11, wherein,
the second fixation member comprises a movable member;
the movable member is movably connected to the first fixation member to adjust a distance between the movable member and the first fixation member to fix the first fixation member to the fixed object.

13. The connection wire according to claim 12, wherein
the second fixation member further comprises a fixation body, and the movable member comprises a screw and a rotation snap;
an end of the screw sequentially extends through and is threadedly connected to the fixation body, the rotation snap, and the first fixation member; a distance between the rotation snap and the first fixation member is adjusted by the rotation snap to fix the first fixation member with the fixed object;
and the other end of the screw is configured to be connected to an external structure.

14. The connection wire according to claim 13, wherein the screw has a size of ¼ inches.

15. The connection wire according to claim 2, wherein,
the fixation component further comprises two fourth fixation members and a fixation plate;
the fixation plate is perpendicular to and fixedly connected to a second side of the body portion;
an end of one of the two fourth fixation members is connected to one of two opposite ends of a side of the fixation plate away from the first connector; and an end of the other one of the two fourth fixation members is connected to the other one of the two opposite ends of the side of the fixation plate away from the first connector;
the two fourth fixation members are bent, enabling the other end of one of the two fourth fixation members and the other end of the other one of the two fourth fixation members to be extending towards each other and to be parallel to the side of the fixation plate away from the first connector; two fixation grooves are formed on the side of the fixation plate away from the first connector.

16. The connection wire according to claim 1, wherein each of the first connector and the second connector is: an HDMI connector, a Type-C female connector, a USB-A connector, a Type-C male connector or a DP connector.
